(19) United States
(12) Patent Application Publication
(10) Pub. No.: US 2016/0293062 A1
(43) Pub. Date: Oct. 6, 2016

(54) Method for Tagging and Identifying Wire Rope and Corresponding Article of Manufacture

(71) Applicant: Mazzella Companies, Cleveland, OH (US)

(72) Inventor: Matt Mazella, Cleveland, OH (US)

(73) Assignee: Mazzella Companies, Cleveland, OH (US)

(21) Appl. No.: 15/089,875

(22) Filed: Apr. 4, 2016

Related U.S. Application Data
(60) Provisional application No. 62/143,397, filed on Apr. 6, 2015.

(51) Int. Cl. G09F 3/00; F16G 11/14

(52) U.S. Cl. CPC G09F 3/0295; F16G 11/14; G09F 2003/0201

(57) ABSTRACT

Provided is a method for tagging and identifying wire rope comprising positioning a fitting over a wire rope having a first end, a second end and an internal portion; securing the fitting to the wire rope; and marking indicia directly onto the fitting with a laser. Also provided is a tagged wire rope comprising at least one fitting positioned and secured over a wire rope having a first end, a second end and an internal portion, wherein the at least one fitting includes indicia directly marked onto the fitting with a laser.

### TECHNICAL FIELD

The following disclosure relates to a method for tagging and identifying wire rope and a corresponding article of manufacture which includes a wire rope tagged and capable of being identified according to the disclosed method.

### BACKGROUND

Lifting and rigging operations typically employ the use of wire rope to lift and move various types of materials. For example, in such operations wire rope is typically formed into the shape of a sling and used to lift and move materials such as large pipes or conduits and as well as other articles of manufacture. Different grades and types of wire rope are typically used for lifting and rigging different types of materials or with different lifting and rigging hardware.

Using the appropriate wire rope for the particular lifting and/or rigging job at hand is of vital importance because using the wrong type of wire rope may result in failure or breakage of the wire rope which can in turn cause serious injury, loss of life and/or severe property damage. The American Society of Mechanical Engineers (ASME) currently requires all wire rope slings to be permanently marked with information related to the particular sling at hand in accordance with ASME B30.9c. Information now required to be marked on wire rope used for lifting and rigging includes the name of the manufacturer, the diameter or size of the wire rope, the rated load for the type of hitch and the angle upon which the rated load is based. If a particular wire rope does not include this information, it may not be used according to ASME standards because of the inherent risks and potential harm and/or damages that may arise if the wrong wire rope is used. Such issues arise if the label on the wire rope falls off or wears away. The present disclosure provides an efficient way to mark or label wire rope with permanent indicia for identification prior to use with various lifting and rigging operations.

### SUMMARY

Provided is a method for tagging wire rope which includes positioning a fitting over a wire rope having a first end, a second end and an internal portion; securing the fitting to the wire rope; and marking indicia directly onto the fitting with a laser.

Also provided is a tagged wire rope which includes at least one fitting positioned and secured over a wire rope having a first end, a second end and an internal portion, wherein the at least one fitting includes indicia directly marked onto the sleeve with a laser.

### BRIEF DESCRIPTION OF THE DRAWINGS

FIG. 1 is a planar view of an exemplary wire rope sling having a fitting with marked indicia.

FIG. 2 is a planar view of an exemplary wire rope sling having a fitting with marked indicia.

FIG. 3 is a close-up perspective view of an exemplary fitting engaged to a wire rope sling having marked indicia.

FIG. 4 is a close-up perspective view of an exemplary fitting engaged to a wire rope sling having marked indicia.

FIG. 5 is a perspective view of an exemplary laser system.

### DETAILED DESCRIPTION

Provided is a method for tagging and identifying wire rope and a corresponding article of manufacture comprising a tagged wire rope which contains indicia for identification.

The method for tagging wire rope may include the steps of positioning a fitting over a wire rope having a first end, a second end and an internal portion; securing the fitting to the wire rope; and marking indicia directly onto the fitting with a laser. In certain embodiments, at least one of the first and second ends of the wire rope may be bowed to form a loop with the internal portion of the wire rope. The fitting may be engaged with an internal portion of the wire rope so that the fitting is positioned over the internal portion of the wire rope. The fitting may be engaged with the internal portion of the wire rope by any means known in the art. For example, the fitting may engage the internal portion of the wire rope by inserting one end of the wire rope within the fitting and pulling the desired length of the wire rope through the fitting or providing a snap-type fitting that fits over the internal portion of the wire rope by snapping two portions of the fitting in place. The fitting, positioned over the internal portion of the wire rope, is capable of receiving the first or second end of the wire rope within the interior of the fitting to form a loop or sling.

After the fitting receives the first or second end of the wire rope, the fitting may then be swagged onto the wire rope to secure the first or second end of the wire rope and the internal portion of the wire rope in place. In certain embodiments, the fitting is a sleeve. The sleeve may be of any shape, size or configuration which is capable of fitting over the wire rope. In certain embodiments, the sleeve is of a cylindrical shape. The fitting or sleeve may be swagged onto the wire rope any process capable of compressing and conforming the fitting or sleeve to the wire rope. For example, a mechanical or hydraulic tool may compress and conform the fitting or sleeve to the wire rope. The swagging process of compressing and conforming the fitting or sleeve onto a wire rope may employ the use of a die and is also known as crimping.

In certain embodiments, the first and second ends of the wire rope are bowed to form a first and second loop with the internal portion of the wire rope. In such embodiments, a first fitting is positioned over the first end and a first point within the internal portion of the wire rope and a second fitting is positioned over the second end and a second point within the internal portion of the wire rope. The first and second fittings then receive the first and second ends of the wire rope within the respective fittings to form a first and a second loop.

Wire rope may be made from any type of metal. Non-limiting examples of materials wire rope may be made from include galvanized steel and stainless steel wire. Wire rope is typically made by winding or braiding multiple cables or strands around each other to form a single unit of wire rope. Non-limiting examples of various types of wire rope include general purpose wire rope (from standard 6×19 and 6×36 rope classifications), rotation resistant wire rope (designed to resist the tendency to spin or rotate under load), high performance wire rope (wire rope having higher breaking strengths, superior bending fatigue life, resistance to crushing and abrasion), aircraft cable (typically provided in galvanized or stainless steel and vinyl coated for protection and wear resistance) and plastic impregnated and special coated wire rope which provides protection against corrosion (plastic coatings may be applied to the outside of the wire rope, incorporated around the core, or the wire rope may be impregnated with a matrix of plastic which extends to the outer circumference of the rope).

The fittings or sleeves employed to form the wire rope slings may be made of any type of metal, including but not limited to aluminum and steel. In certain embodiments, the fittings or sleeves employed to form the wire rope slings are made from mild steel or stainless steel.

Indicia are marked directly onto the sleeve of the wire rope with a laser. In certain embodiments, indicia may be marked directly onto the sleeve by laser marking whereas in other embodiments, indicia may be marked directly onto the sleeve by laser engraving. Laser engraving (also known as laser etching) is a process of using a laser to engrave or cut marks into an object. Laser marking, on the other hand, is a process of using a laser to discolor the surface of an object for printing marks onto the surface without cutting into the surface. The marked indicia may indicate the load bearing capacity of the sling, the name of the manufacturer of the sling, the diameter and length (size) of the wire rope, the rated load for the type of hitch that may be used with the wire rope and the angle upon which the load bearing capacity of the wire rope is based. Indicia may be marked onto the fitting either before or after assembly of the wire rope sling. The indicia marked on the sleeve of the wire rope may be used to identify the wire rope. For example, the following indicia (set forth in Table I) may be laser engraved or laser marked onto the first and/or second ends of a fitting (e.g., a sleeve) of a wire rope sling depending on the particular sling size and surface size of the fitting.

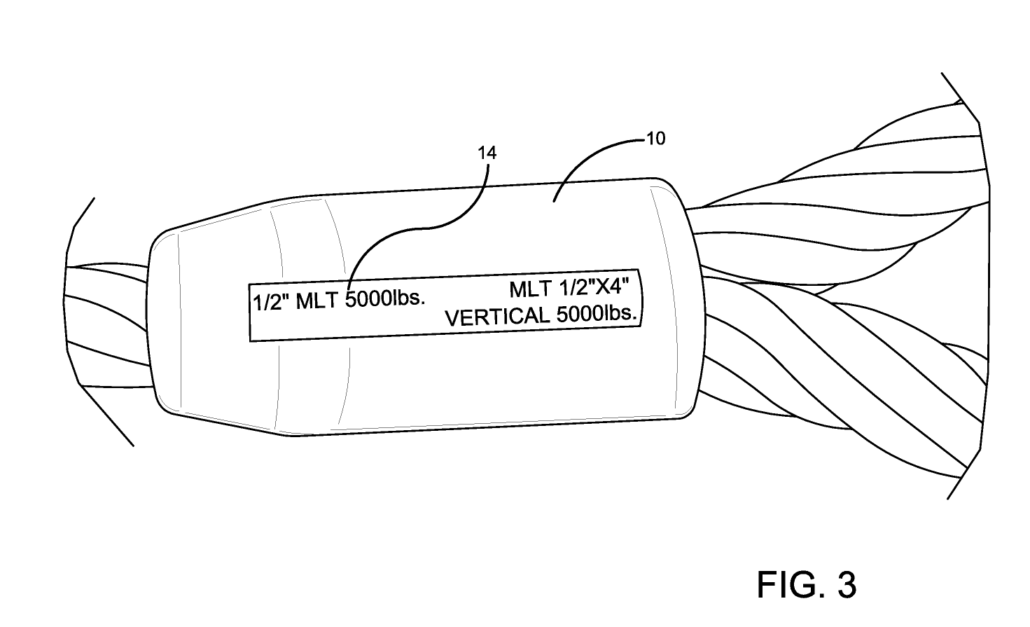

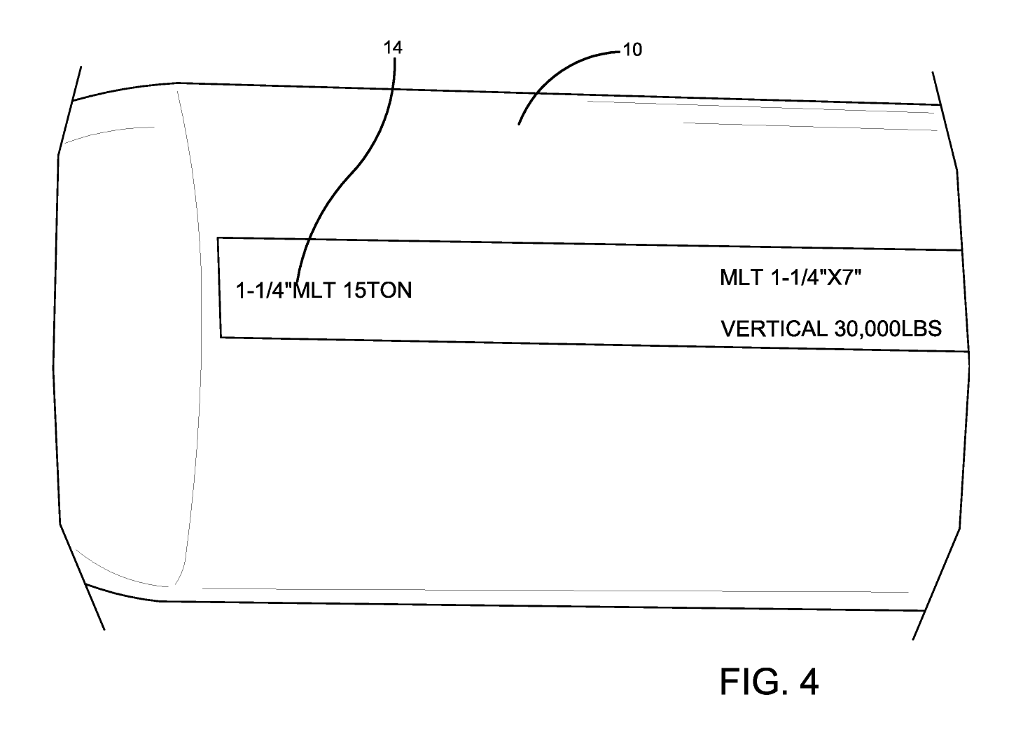

TABLE I

| | | Marking on First End | Marking on Second |
|---|---|---|---|
| | Surface | or Half of Fitting as | Half or End of Fitting |
| | Size of the | Illustrated in FIGS. | as Illustrated in |
| Sling Size | Fitting | 3 and 4 | FIGS. 3 and 4 |
| ⅜″ × 4′ | ½″ × 1¼″ | ⅜″ MLT 2800 lbs. | MLT ⅜″ × 4′ |
| | | | Vertical 2800 lbs. |
| ½: × 4′ | ⅝″ × 1¼″ | ½″ MLT 5000 lbs. | MLT ½″ × 4′ |
| | | | Vertical 5000 lbs. |
| 1¼: × 8′ | 1: × 4¼″ | 1¼″ MLT 15 Ton | MLT 1¼″ × 8′ |
| | | | Vertical 30,000 lbs. |

The tagged wire rope provided herein may include at least one fitting positioned and secured over a wire rope having a first end, a second end and an internal portion, at least one fitting which includes indicia directly marked onto the fitting with a laser, and any of the features described above with regard to the method.

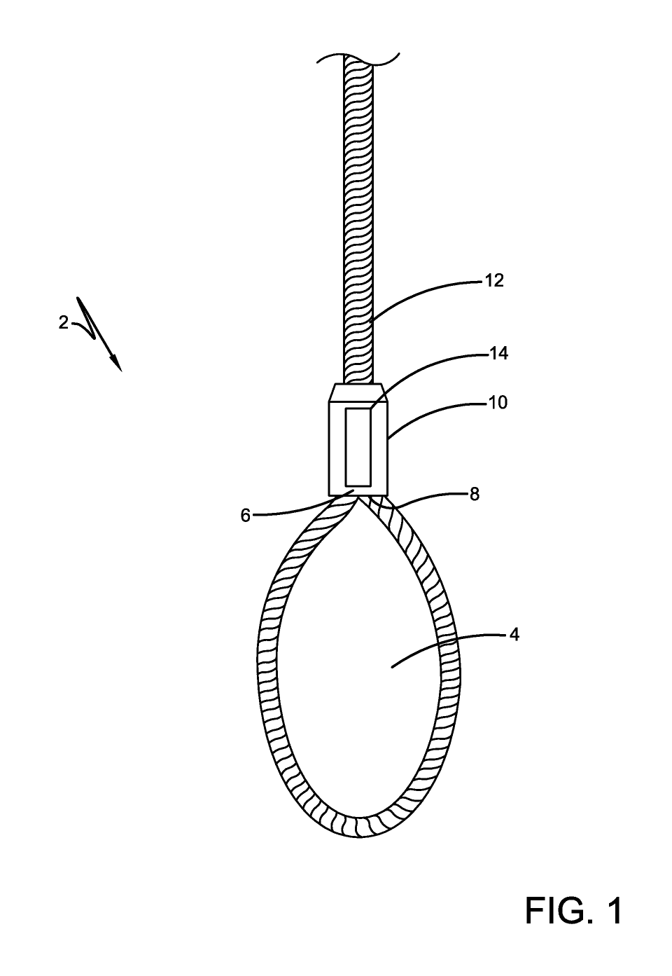

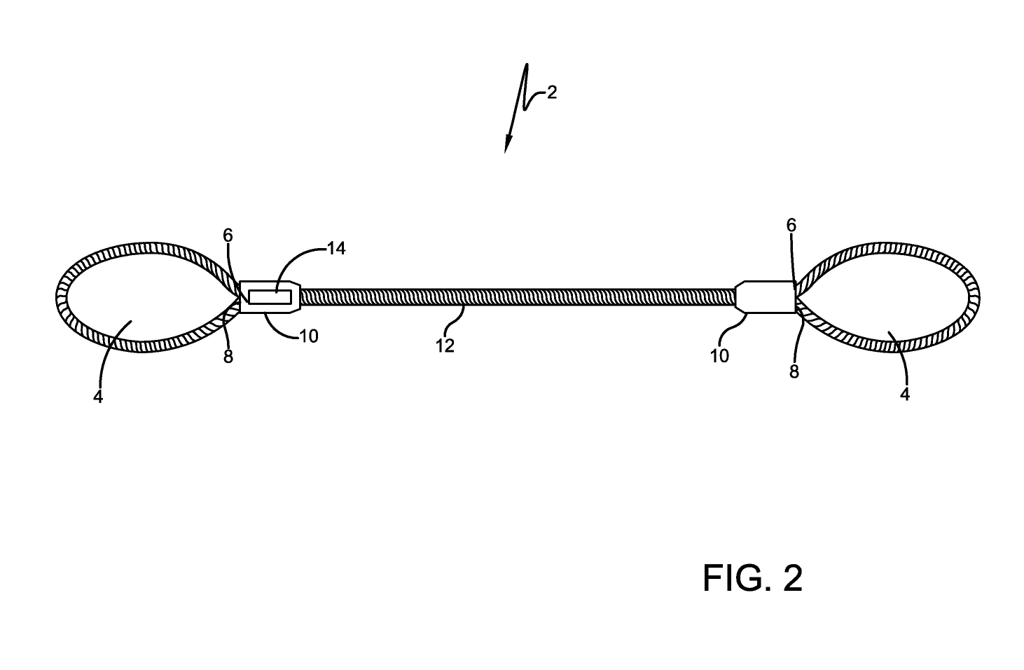

With reference to FIG. 1, an exemplary wire rope sling (2) having one end formed in the shape of a loop is illustrated. The wire rope sling (2) includes an eyelet (4) which is formed by inserting a first end (6) of the wire rope and an internal portion (8) of the wire rope through a fitting (10). The remaining portion of the wire rope (12) passes through the fitting (10) forming the wire rope sling (2). Included on the fitting (10) are indicia (12) marked on the fitting (10) with a laser. FIG. 2 illustrates two ends of an exemplary wire rope sling (2) in the shape of a loop. Each end of the wire rope sling (2) has an eyelet (4) formed by inserting an end (6) of the wire rope and an internal portion (8) of the wire rope through a fitting (10) with the remaining portion of the wire rope (12) passing through the fitting (10) to form the wire rope sling (2). FIG. 2 includes one fitting (10) having indicia (14) marked therein with a laser.

FIG. 3 illustrates a close up view of an exemplary fitting (10) engaged to a wire rope sling having marked indicia (14). The indicia (14) marked onto the fitting (10) of FIG. 3 includes the name of the manufacturer (MLT), the size of the wire rope sling (diameter and length—½″×4′) and the load bearing capacity (vertical 5000 lbs) of the wire rope sling. FIG. 4 illustrates a close-up perspective view of an exemplary fitting (10) having marked indicia (14). The indicia (14) marked onto the fitting (10) of FIG. 4 includes the name of the manufacturer (MLT), the size of the wire rope sling (diameter and length—1¼″×8′) and the load bearing capacity (vertical 30,000 lbs or 15 Ton) of the wire rope sling.

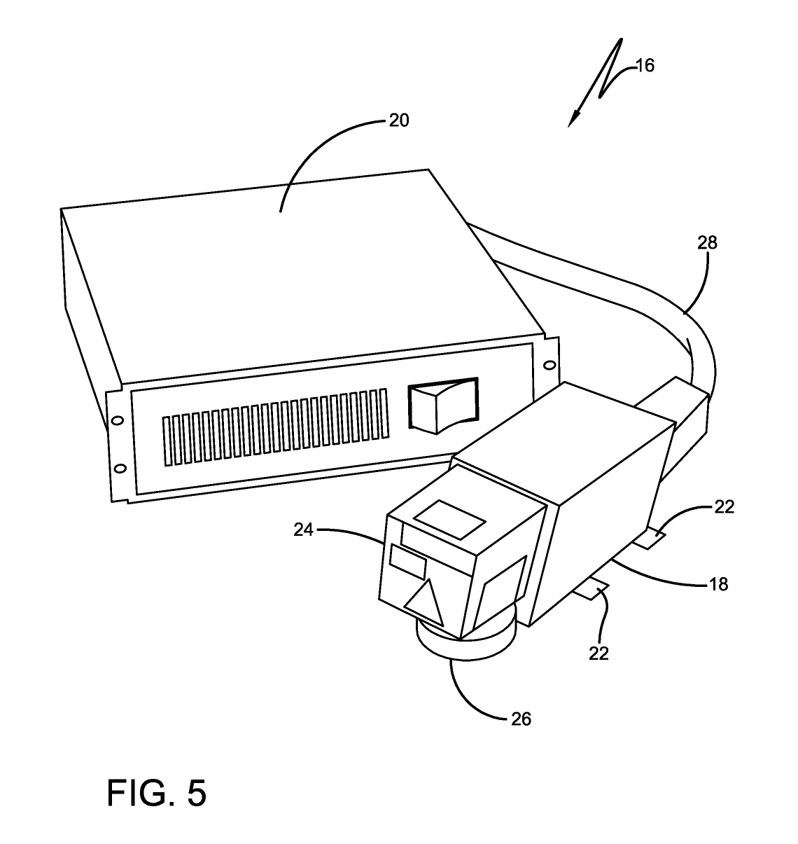

FIG. 5 illustrates an exemplary laser system (16) which may be used to laser engrave or laser mark indicia on the fitting secured to a wire rope or wire rope sling. The laser system (16) includes a control unit (20), a laser head (18) connected to the control unit (20) by electrical wiring (28), a scan head (24) connected to laser head (18), an optical lens (26) on the front side of the scan head (24) and two mounting plates (22) for mounting the laser head (18) onto a surface prior to use. The laser system may consist of a maintenance free Ytterbium fiber source laser (Galvo fiber laser) having a maximum output power ranging from about 10 to about 50 watts, a wave length of 1064 nm +/−8 nm, a repetition rate of up to about 80 kHz, a focus diameter of approximately 45 μm and a working area ranging from about 2.8×2.8 inches to about 12.2×12.2 inches. In certain embodiments, the laser system has a power output of about 30 watts. The control unit (20) is used to set the precise movements of the laser emitted from the optical lens (26) of the scan head (24) onto the surface to be laser engraved or laser marked with indicia.

The above-described method and article of manufacture provides a permanent label on a fitting or sleeve of a wire rope sling ensuring that the appropriate wire rope sling is selected for the job at hand and that the label will not fall off or wear away rendering the wire rope sling unusable according to ASME standards.

While the tagged wire rope, its various components and the associated method have been described above in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the tagged wire rope, its various components and the associated method should not be limited to any single embodiment, but rather construed in breadth and scope in accordance with the recitations of the appended claims.

What is claimed is:

1. A method for tagging wire rope comprising: positioning a fitting over a wire rope having a first end, a second end and an internal portion; securing the fitting to the wire rope; and
marking indicia directly onto the fitting with a laser.

2. The method of claim 1, wherein at least one of the first and second ends of the wire rope is bowed to form a loop with the internal portion of the wire rope, wherein the fitting is positioned over the internal portion of the wire rope and wherein the fitting receives the first or second end of the wire rope within the fitting to form the loop.

3. The method of claim 2, wherein the fitting is swagged onto the wire rope to secure the first or second end of the wire rope and the internal portion of the wire rope in place.

4. The method of claim 1, wherein the indicia is marked directly onto the fitting by laser marking.

5. The method of claim 1, wherein the indicia is marked directly onto the fitting by laser engraving.

6. The method of claim 1, wherein the marked indicia indicates the load bearing capacity of the sling, the name of the wire rope manufacturer, the diameter and length of the wire rope, and the angle upon which the load bearing capacity of the wire rope is based.

7. The method of claim 3, wherein the fitting comprises a cylindrical sleeve.

8. The method of claim 1, wherein the first and second ends of the wire rope are bowed to form a loop with the internal portion of the wire rope, wherein a first fitting is positioned over the first end and a first point within the internal portion of the wire rope and wherein a second fitting is positioned over the second end and a second point within the internal portion of the wire rope, wherein the first and second fittings receive the first and second ends of the wire rope within the respective fittings to form a first and a second loop.

9. The method of claim 1, wherein the indicia is marked on the fitting prior to assembly of the wire rope sling.

10. The method of claim 1, wherein the indicia is marked onto the fitting after assembly of the wire rope sling.

11. The method of claim 1, wherein the indicia marked on the fitting of the wire rope is used to identify the wire rope.

12. A tagged wire rope comprising: at least one fitting positioned and secured over a wire rope having a first end, a second end and an internal portion, wherein the at least one fitting includes indicia directly marked onto the fitting with a laser.

13. The tagged wire rope of claim 12, wherein at least one of the first and second ends of the wire rope is bowed to form a loop with the internal portion of the wire rope, wherein the fitting is positioned over the internal portion of the wire rope and wherein the fitting receives the first or second end of the wire rope within the fitting to form the loop.

14. The tagged wire rope of claim 13, wherein the fitting is swagged onto the wire rope to secure the first or second end of the wire rope and the internal portion of the wire rope in place.

15. The tagged wire rope of claim 12, wherein the indicia is marked directly onto the fitting by laser marking.

16. The tagged wire rope of claim 12, wherein the indicia is marked directly onto the fitting by laser engraving.

17. The tagged wire rope of claim 12, wherein the marked indicia indicates the load bearing capacity of the sling, the name of the wire rope manufacturer, the diameter and length of the wire rope, and the angle upon which the load bearing capacity of the wire rope is based.

18. The tagged wire rope of claim 14, wherein the fitting comprises a cylindrical sleeve.

19. The tagged wire rope of claim 12, wherein the first and second ends of the wire rope are bowed to form a loop with the internal portion of the wire rope, wherein a first fitting is positioned over the first end and a first point within the internal portion of the wire rope and wherein a second fitting is positioned over the second end and a second point within the internal portion of the wire rope, wherein the first and second fittings receive the first and second ends of the wire rope within the respective fittings to form a first and a second loop.
